(19) United States
(12) Patent Application Publication
(10) Pub. No.: US 2003/0061334 A1
(43) Pub. Date: Mar. 27, 2003

(54) Method, apparatus, system, computer program and computer program product of network management

(75) Inventors: Toshiaki Hirata, Kashiwa (JP); Akihiro Urano, Sagamihara (JP); Masaaki Oya, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/152,545

(22) Filed: May 20, 2002

(30) Foreign Application Priority Data
Sep. 25, 2001 (JP) 2001-292225

(51) Int. Cl. G06F 15/173

(52) U.S. Cl. 709/223

(57) ABSTRACT

The present invention is to lighten the burden imposed on a network manager. In a management host for managing a management object group on a network, a management information storing unit stores management informations containing attribute informations of management objects and has states of the management objects reflected every management object, a network drawing receiving unit receives design drawing data containing symbols correspond to the management objects and has the attribute information of the management object set, a data converting unit generates the management information, on which the states of the management objects corresponding to the symbols of the design drawing data received by the network drawing receiving unit are reflected, from the attribute information of the symbols, and a management information registering unit registers the management information generated by the data converting unit in the management information storing unit.

### BACKGROUND OF THE INVENTION

1. Field of the Invention

The present invention relates to the technology for supporting the network operation and management works of a network manager.

2. Description of the Related Art

For the design of a network such as a LAN (Local Area Network), first of all, a network diagram showing the connection relationship of network apparatuses (information processors, routers, and a HUB), the physical arrangement thereof and the like is produced. It is general for a network manager to produce such a network diagram using the graphic application on an information processor by taking the convenience and the like in the later maintenance.

Now, some of network system management tools utilized in the operation stage of a network display resources (an information processor, a router or the like, hereinafter, referred to as “management object”) which are object to a management on the display device, and also display visually such as state information of management objects on that network construction diagram.

However, a network manager needs to maintain and manage individually the network diagram produced using the above-mentioned conventional graphic application and the network construction diagram of the above-mentioned network management tool. Therefore, a burden for management imposed on a network manager is large.

### SUMMARY OF THE INVENTION

Therefore, an object of the present invention is to lighten the burden of the operation and management imposed on a network manager.

In order to attain the above-mentioned object, in one aspect of the present invention, it is provided that a management supporting method for supporting operation and management works by a management host managing a plurality of management objects, means for generating management informations, on which states of the management objects corresponding symbols contained in design drawing data are reflected, based on attribute information of the symbols, and registering the management informations in a database. Now, the management informations are stored in the database per management object by the management host and contain the attribute informations of the management objects, and on which the states of the management objects are reflected. In addition, the design drawing data received by the management host contains the symbols which are associated with to the management objects respectively, and set the attribute information of the management objects.

In addition, it is more preferable for the above-mentioned management supporting method to generate a drawing for management on which the symbols are arranged, in the form of the data for display in the transmission request site. Now, the symbols are set with the attribute information, contained in each management information, and when receiving a request for the drawing for management, are respectively generated by fetching management informations from the database of the management objects for showing in the drawing for management.

Further, for the above-mentioned management supporting method, it is more preferable to delete from the database the management information of the management object, for which no management information is newly generated from the design drawing data, of the management objects having the management information registered in the database.

Furthermore, for the above-mentioned management supporting method, it is more preferable that the symbols which have been generated from a plurality of sets of management information fetched from the database are classified into a plurality of groups in accordance with the predetermined rules to produce every group the above-mentioned drawing for management in which the symbols belonging to the group of interest are arranged.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing construction of the whole network system according to an embodiment of the present invention;

FIG. 2 is a block diagram showing a configuration of hardware of an information processor according to an embodiment of the present invention;

FIG. 3 is a diagram showing conceptually data structure in a management database according to an embodiment of the present invention;

FIG. 4 is a block diagram showing a functional configuration of a management host according to an embodiment of the present invention;

FIG. 5 is a block diagram showing a functional configuration of a terminal for network design according to an embodiment of the present invention;

FIG. 6 is a block diagram showing a functional configuration of a terminal for network design according to an embodiment of the present invention;

FIG. 7 is a flow chart explaining the processing, for supporting network management, executed in a network system according to an embodiment of the present invention;

FIG. 8 is a schematic diagram showing one example of a network drawing used in generation of management object information registered in a management database according to an embodiment of the present invention;

FIG. 9 is a diagram showing conceptually data structure of a management database according to an embodiment of the present invention;

FIG. 10 is a flow chart explaining the processing, for supporting network management, executed in a network system according to an embodiment of the present invention;

FIG. 11 is a flow chart explaining the processing, for supporting network management, executed in a network system according to an embodiment of the present invention;

FIG. 12 is a diagram showing one example of a network construction drawing displayed on a management console screen according to an embodiment of the present invention;

FIG. 13 is a flow chart explaining the processing, for supporting network management, executed in a network system according to an embodiment of the present invention;

FIG. 14 is a diagram showing one example of a job-net drawing and a network drawing according to an embodiment of the present invention;

FIG. 15 is a diagram showing conceptually data structure of job-net management information contained in management information according to an embodiment of the present invention; and

FIG. 16 is a diagram showing conceptually data structure of job management information contained in management information according to an embodiment of the present invention.

### DESCRIPTION OF THE EMBODIMENTS

The embodiments of the present invention will hereinafter be described in detail with reference to the accompanying drawings.

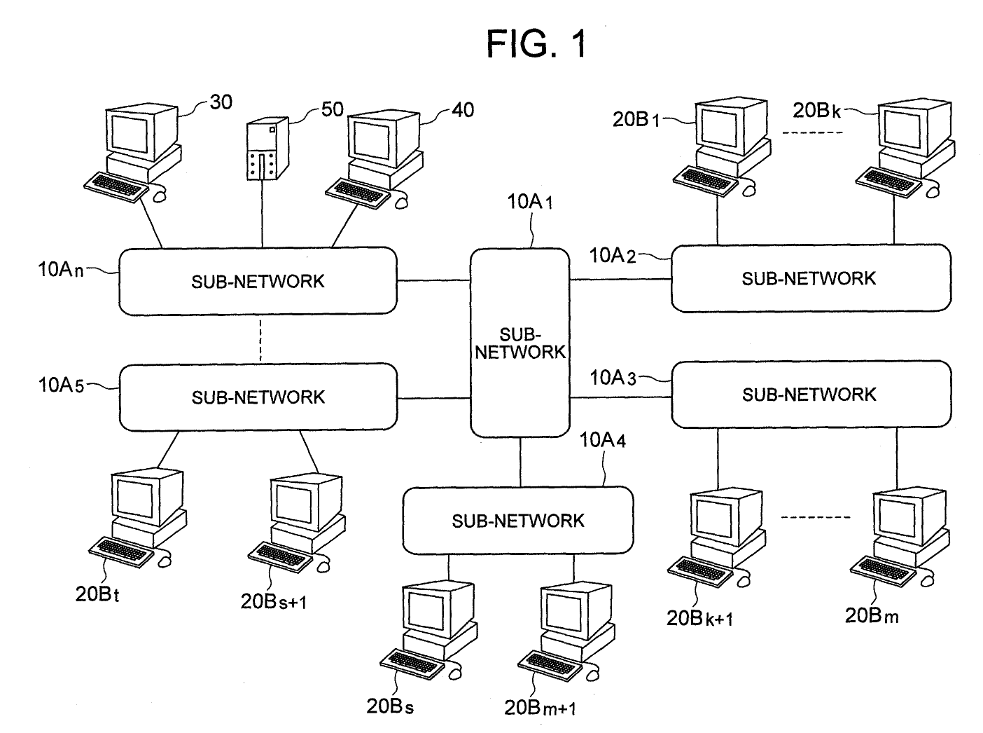

FIG. 1 is a schematic diagram showing construction of the whole network system according to an embodiment of the present invention.

The present information processing system includes sub-networks (a LAN and the like) 10A1, 10A2, . . . , 10An which are interconnected to one another within a site, information processors 50, 30, 40, 20B1, . . . , 20Bk, 20Bk+1, . . . , 20Bm, 20Bm+1, . . . , 20Bs, 20Bs+1, . . . , 20Bt each of which is connected to one of the sub-networks in the site, and routers which are provided between the sub-networks.

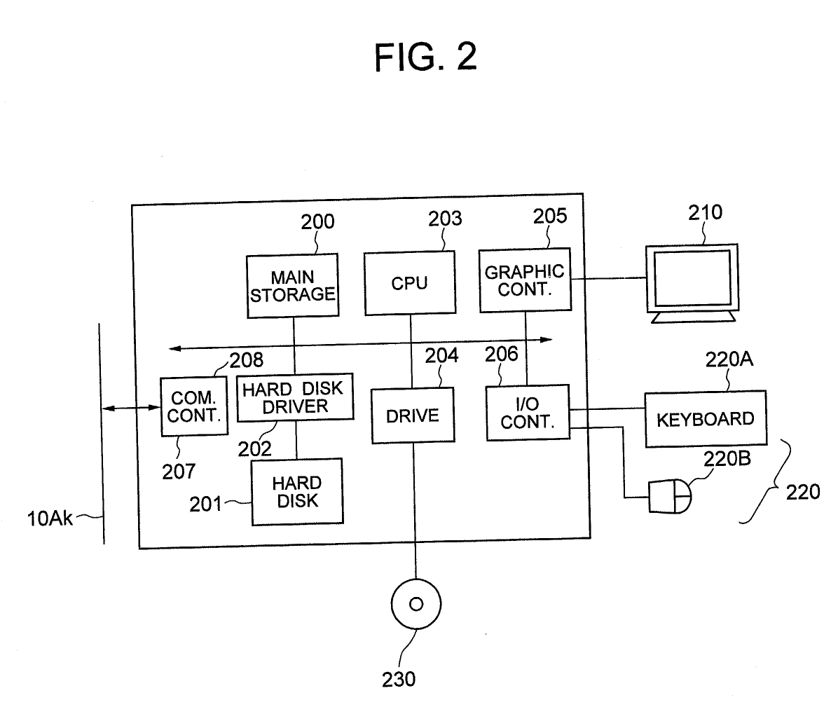

FIG. 2 is a block diagram showing a configuration of hardware of an information processor according to an embodiment of the present invention.

Each of the information processors 50, 30, 40, 20B1, . . . , 20Bk, 20Bk+1, . . . , 20Bm, 20Bm+1, . . . , 20Bs, 20Bs+1, . . . , 20Bt has the hardware construction, as the normal information processor, including: a hard disc 201 in which an operating system program (OS) and the like are already installed; a hard disc drive 202 for executing the processing for reading out/writing data from/to the hard disc 201; a main storage 200; a CPU 203 for executing the various kinds of programs loaded from either the hard disc 201 or a portable storage medium (e.g., an optical disc such as a CD-ROM) to the main storage 200; a drive 204 for controlling the processing for reading out data from the portable storage medium; a graphic controller 205 for controlling the data transfer to a display device 210; an I/O controller 206 for controlling the data transfer from an input unit (a keyboard 220A, a mouse 220B or the like); a communication controller 207 for controlling the communication with other information processors on the network; a bus 208 through which the above-mentioned elements are coupled to one another; and the like.

Now, a manager program and a Web server program are installed in the hard disc of at least one information processor 50 (hereinafter, referred to as “management host”) of those information processors 50, 30, 40, 20B1, . . . , 20Bk, 20Bk+1, . . . , 20Bm, 20Bm+1, . . . , 20Bs, 20Bs+1, . . . , 20Bt. Since these manager programs are activated by the OS in activation of the management host, the managers resident as the process on the management host 50 being activated.

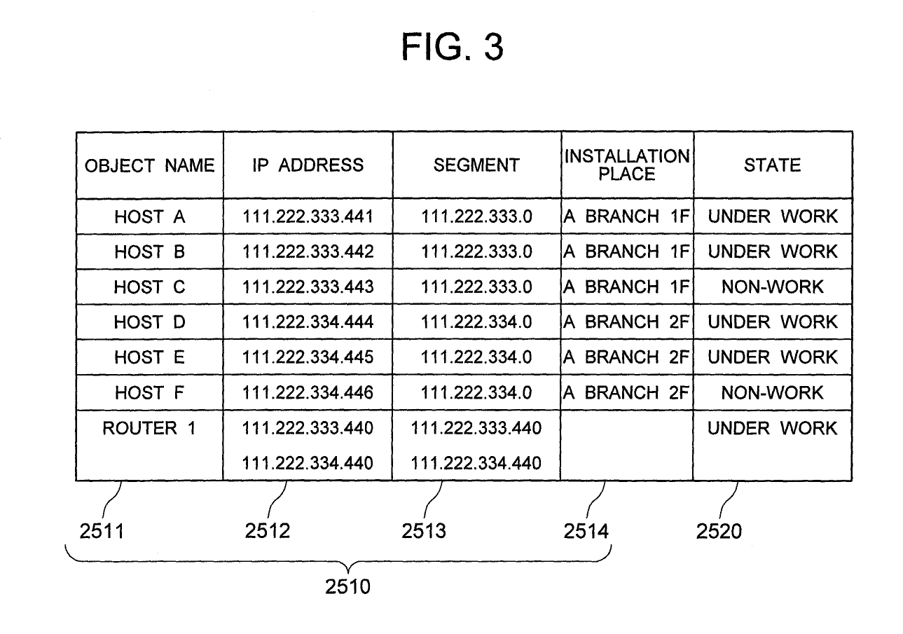

FIG. 3 is a diagram showing conceptually data structure in a management database according to an embodiment of the present invention.

A management database being registered the management information concerned with a management object (an information processor, a router or the like) in which each of the agent controlled by a manager residents, in the hard disc of this management host 50. Now, management object information 2510 and state information 2520 are both contained in the management information of each of the management objects. Then, for example, attribute information such as the kind of object (not shown), an object mane 2511, an IP address 2512, an installation place 2514, and segment information 2513 representing the connection relationship is contained in the management object information 2510.

On the other hand, agent programs are respectively installed in hard discs of other information processors 30, 40, 20B1, . . . , 20Bk, 20Bk+1, . . . , 20Bm, 20Bm+1, . . . , 20Bs, 20Bs+1, . . . , 20Bt each becoming a management object (including a network apparatus such as a server, a router and etc. hereinafter, referred to as “management object”). Since these agent programs are activated by the OS when the terminals are activated, agents controlled by a manager of the management host 50 resident as processes on the activated management objects 30, 40, 20B1, 20Bk, 20Bk+1, . . . , 20Bm, 20Bm+1, . . . , 20Bs, 20Bs+1, . . . , 20Bt, respectively.

Furthermore, a management application program providing a user interface (hereinafter, referred to as “consor screen for management”) which is utilized when a network manager carries out the network operation and management works is further installed in the hard disc of a management object (hereinafter, referred to as “terminal for network management”, when applicable) 21, which is used as the console for network management, of those management objects 30, 40, 20B1, . . . , 20Bk, 20Bk+1, . . . , 20Bm, 20Bm+1, . . . , 20Bs, 20Bs+1. . . , 20Bt. Also, a graphic application program utilized in production of the network drawing (drawing for design), and a management application program providing a user interface (hereinafter, referred to as “console screen for design”) which is utilized in registration of the network drawing data are further installed in the hard disc of a management object (hereinafter, referred to as “terminal for network design”) 22 which is used in the network design. By the way, it is no object for these programs whether or not they are installed from the portable storage medium mounted to the drive, and whether or not they are installed through the network line.

In such a network system, a manager of the management host 50, by performing message exchanges with each of agents under its management and acquiring state informations from the management objects in which those agents resident, regists them in the management database. In addition, when received a request from the network management terminal 21, in response to this request, the manager executes the processings such as a remote setting of attribute informations of the management objects, and a returning management informations stored in the management database. On the other hand, the agents of the management objects collect periodically state informations of the management objects in which they resident and also execute such a processing to response to a command from the manager in the management host 50.

Next, the description will hereinbelow be given with respect to the functional configurations of the management host 50, the terminal 40 for network management 40 and the terminal 30 for network design.

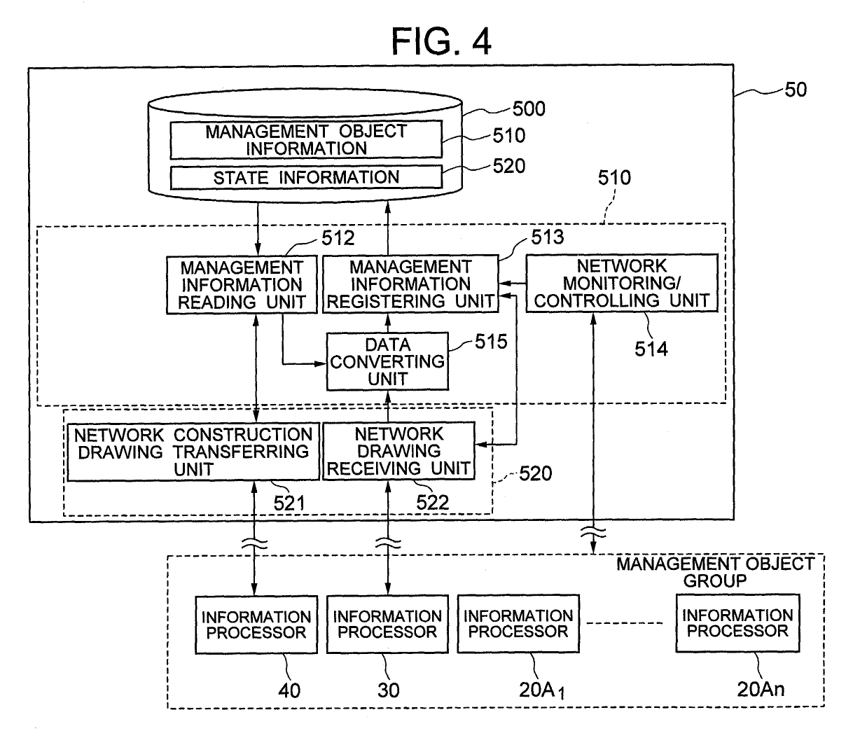

FIG. 4 is a block diagram showing a functional configuration of the management host according to an embodiment of the present invention.

In the management host 50, the functional configuration shown in FIG. 4 is realized by the hardware, the software etc. described above. To put it concretely, a management information storing unit (management database) 500 having the management information stored therein, a data transmitting/receiving unit 520 for communicating with either the terminal 40 for network management or the terminal 30 for network design, and a management processing executing unit 510 for executing the management processing for the management objects 30, 40, 20B1, 20Bk, 20Bk+1, . . . , 20Bm, 20Bm+1, . . . , 20Bs, 20Bs+1, . . . , 20Bt, are realized. Now, the data transmitting/receiving unit 520 includes (1) a network construction drawing transferring unit 521 for returning network construction drawing data to the network management terminal 40, in response to a transmission request for the network construction drawing (drawing for management) representing the state of the network system, and (2) a network drawing receiving unit 522 for receiving a registration request for the network drawing data from the terminal 30 for network design. In addition, the management processing executing unit 510 includes (1) a network monitoring/controlling unit 514 for carrying out the state information collection from the management objects 30, 40, 20B1, . . . , 20Bk, 20Bk+1, . . . , 20Bm, 20Bm+1, . . . , 20Bs, 20Bs+1, . . . , 20Bt and the construction information setting for the management objects 30, 40, 20B1, . . . , 20Bk, 20Bk+1, . . . , 20Bm, 20Bm+1, . . . , 20Bs, 20Bs+1, . . . , 20Bt by referring to the management information stored in the management information storing unit 500, (2) a management information reading out unit 512, when a network construction drawing transferring unit 521 has received a request to transmit a network construction drawing, in response to this request, reading out the management information from the management information storing unit 500, (3) a data converting unit 515, when a network drawing receiving unit 522 has received a registration request, converting network drawing data contained in this registration request into management object information, and when the network construction drawing transferring unit 521 has received a request to transmit a network construction drawing, generating network construction drawing data, which the network construction drawing transferring unit 521 is to return, from the management information read out by the management information reading unit 512, and (4) a management information registering unit 513 storing management object information generated by the data transferring unit 503 and state informations collected by the network monitoring/controlling unit 514 in the management information storing unit 500.

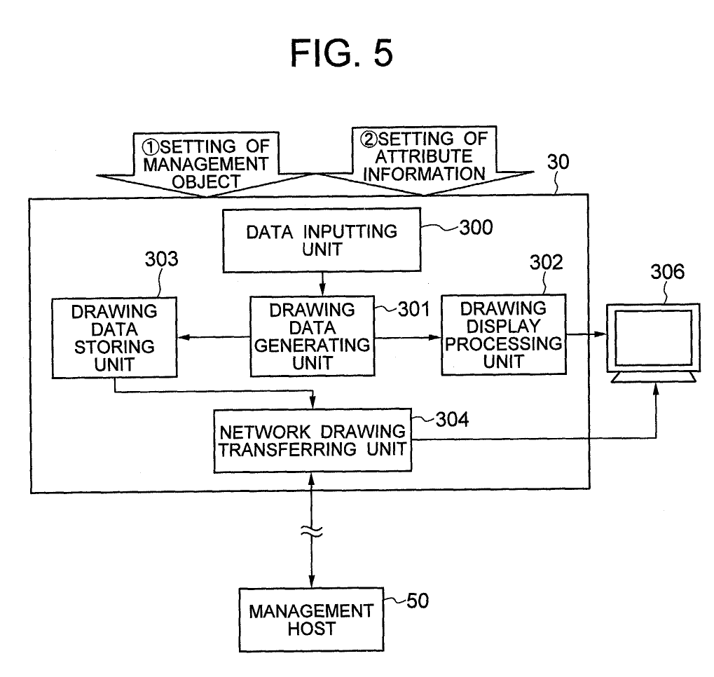

FIG. 5 is a block diagram showing a functional configuration of the terminal for network design according to an embodiment of the present invention.

In the network design terminal 30, the functional configuration shown in FIG. 5 is realized by the hardware, the software and the like as described above. To put it concretely, there are realized (1) a data inputting unit 300 for receiving a data input for drawing production (an input of drag and drop of symbols representing network apparatuses, and attribute information, and the like) from a network designer, (2) a drawing data generating unit 301 for generating network drawing data from the data received by the input receiving unit 300, (3) a drawing data storing unit 303 for holding network drawing data generated by the drawing data generating unit 301, (4) a drawing display processing unit 302 for making a display unit 306 display the network drawing represented by the network drawing data generated by the drawing data generating unit 301, and (5) a network drawing transferring unit 304 for when having received an instruction to transmit the network drawing data from a network designer, transmitting the network drawing data stored in a drawing storing unit 305.

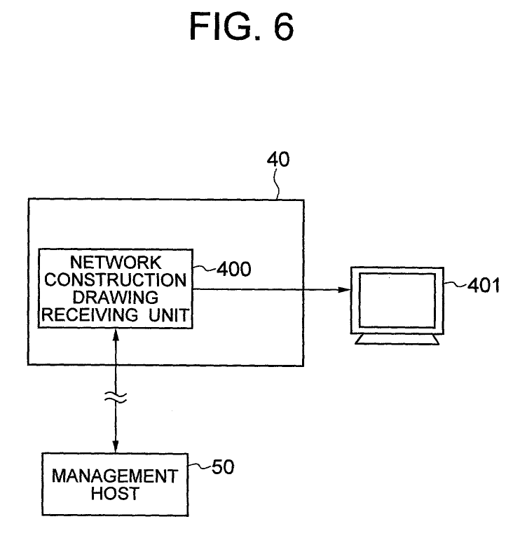

FIG. 6 is a block diagram showing a functional configuration of the terminal for network management according to an embodiment of the present invention.

In the network management terminal 40, the functional configuration shown in FIG. 6 is realized by the hardware, the software and the like as described above. To put it concretely, there is realized (1) a network construction drawing receiving unit 400 for making a display device 401 display the console screen for management through which an instruction to transmit the network management drawing data is received, and for making the display device 401 display network construction drawing data sent as a reply from the management host 50.

Next, the description will hereinbelow be given with respect to the processing for supporting the network management according to the present embodiment.

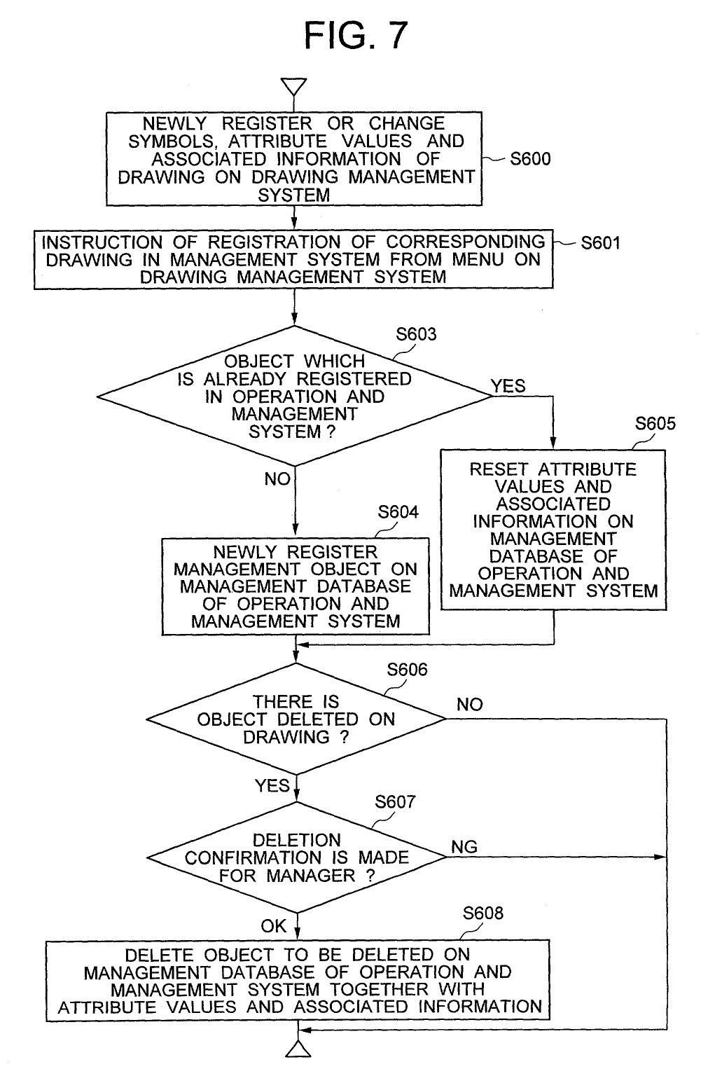

FIG. 7 is a flow chart of a processing for generating management informations of the management objects from the network drawing data and registering them in the management database.

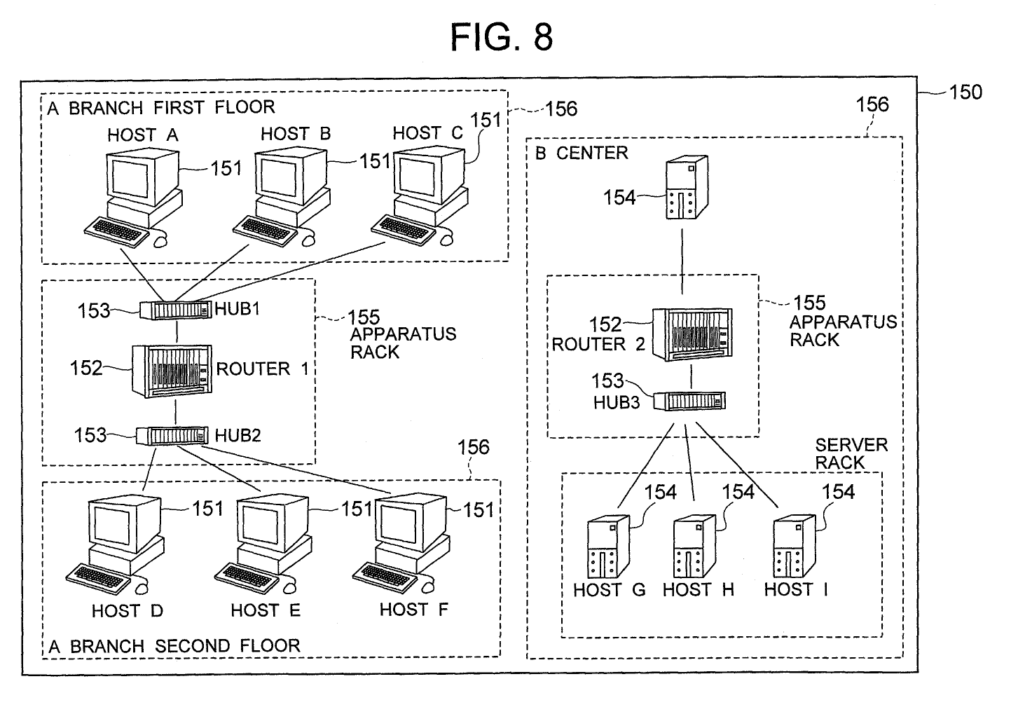

Prior to the construction or change of the network system, a network designer, first of all, produces or corrects the network drawing by using a graphic application program in the network design terminal 30, and then storing it in the hard disc. As shown in FIG. 8, symbols 151, 152, 153 and 154 of the network apparatuses constituting the network system are arranged in the network drawing 150 thus produced or changed at this time, and attribute informations of the network apparatuses (e.g., an IP address, a network apparatus name, an installation place, segment information representing a logical connection relationship, and the like) are set, respectively (Step S600).

FIG. 8 is a schematic diagram showing an example of the network drawing used in generation of the management object information registered in the management database according to an embodiment of the present invention.

In the network drawing shown in FIG. 8, reference numeral 155 designates a rack for apparatuses in which a plurality of network apparatuses (a router 152, a HUB 153 and the like) are accommodated, and reference numeral 156 designates a segment representing the logical connection relationship between the hosts.

After having constructed or changed the network system in accordance with such a network drawing, a network designer activates the management application program in the network design terminal 30, thereby displaying the console screen for design on the display device. Then, a network manager inputs the file name in which the newest network drawing data including the symbol data is stored to instruct to register that file name on the console screen for design. As a result, the registered request containing the network drawing data is transmitted from the network design terminal 30 to the management host 50 (Step S601).

When received a request for registering the network drawing data, the management host 50 executes the following processings (Steps S603 to S606) using the network drawing data contained in that registration request.

First of all, the data converting unit 515 fetches symbol data of predetermined kinds of network apparatuses each becoming the management object from the network drawing data, and converting the data format of these symbols into the data format of management object information registerable in the management information storing unit 500. As a result, a management information registering unit 513 retrieves the management object information, which contains the same data with a predetermined data (e.g., an address) contained in the generated management object information, in a management information storing unit S500 (Step S603).

If the corresponding management object information is absent in the management information storing unit 500, then the management information registering unit 513 registers newly the management information containing therein the management object information generated by the data converting unit 515 in the management database 500 (Step S604).

On the other hand, if the corresponding management object information is present in the management information storing unit 500, then the management information registering unit 513 updates the management object information of interest to register the management object information generated by the data transferring unit 515 instead of the management object information of interest (Step S605). To put it concretely, a difference in information between the management object information generated by the data converting unit 515 and the management object information found out from the management information storing unit is calculated, and only the resultant difference information is updated and registered.

In such a manner, after registered all of management object informations generated from the network drawing data in the management information registering unit 513, the management information registering unit 513 judges whether or not the symbol data is deleted from the network drawing data (Step S605). For example, the procedure may be adopted in which if the management information other than the management object information generated from the network drawing data is absent within the management information storing unit 500, then it is judged that no symbol data is not deleted from the network drawing data.

If it is judged in Step S605 that the symbol data is not deleted from the network drawing data, then a network drawing receiving unit 522 returns a message representing that the registration of the network drawing data has been completed to the network design terminal 30, in accordance with an instruction of the management information registering unit 513. As a result, the message representing that the registration of the network drawing data has been completed is displayed on the console screen of the display device of the network design terminal 30.

On the other hand, if it is judged that the symbol data is already deleted from the network drawing data, then the network drawing receiving unit 522 returns a message for inquiring whether or not the symbol data should be deleted from the network drawing data to the network design terminal 30, in accordance with an instruction issued from the management information registering unit 513 (Step S606). As a result, a message representing that the symbol data has been deleted from the network drawing data, an OK button for receiving an instruction to execute the deletion of the symbols, and a Cancel button for receiving an instruction to cancel the deletion of the symbols are all displayed on the console screen of the display device of the network design terminal 30.

Now, if the network manager clicks the OK button, then a request to execute a deletion of the symbols is transmitted from the network design terminal 30 to the management host 50. In the management host 50, when the network drawing receiving unit 522 receives that request, the management information registering unit 513 deletes the management information, other than the management information containing therein the management object information generated from the network drawing data, from the management information storing unit 500 (Step S606). Thereafter, in accordance with an instruction from the management information registering unit 513, the network drawing receiving unit 522 returns a message representing that the registration of the network drawing data has been completed to the network design terminal 30 and then this message is displayed on the console screen of the display device of the network design terminal 30.

On the other hand, if the network manager clicks the Cancel button, a request to cancel the deletion of the symbols is transmitted from the network design terminal 30 to the manager host 50. In the manager host 50, when the network drawing receiving unit 522 receives this request, in accordance with an instruction from the management information registering unit 513, the network drawing receiving unit 522 returns a message representing that the registration of the network drawing data has been completed to the network design terminal 30, and this message is displayed on the console screen of the display unit of the network design terminal 30.

In such a manner, after the management information concerned with the management objects on the network system has been registered in the management information storing unit 500, the network monitoring/controlling unit 514 suitably collects state informations of the management objects corresponded to those management information and sets the construction information.

In accordance with the above-mentioned processings, the management object information is automatically generated from the network drawing data which was either produced or changed in network construction or in change of the network construction to be registered in the management database. For this reason, it is possible for the network manager to save the labor required for an initialization and a setting change of management object informations, which are conventionally carried out in execution of the operation and management of the network system. Therefore, the burden of the work in operation and management of the network system is lightened.

Now, the network drawing produced by a network designer may be constituted by a plurality of drawings associated with one another, and within these drawings, some drawings may be set as destinations of link of other drawings. For example, in the case where the network drawing is divided into the general drawing and the partially detailed drawing, a plurality of lines connecting two symbols are represented in the form of one symbol on the general drawing, and each of the individual lines is represented in the form of one symbol on the partially detailed drawing, the partially detailed drawing may be set as the link destinations of the symbols on the general drawing in some cases.

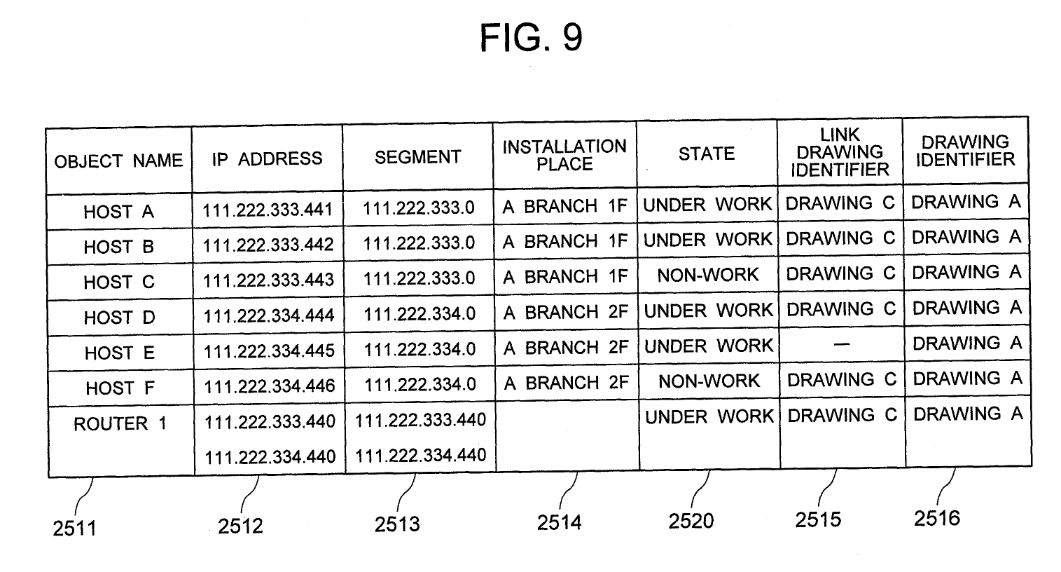

FIG. 9 is a schematic diagram showing conceptually the data structure in the management database according to an embodiment of the present invention.

In the case shown in FIG. 9, it is desirable that a data area in which a drawing identifier 2516 identifying the drawing used to generate the management information and a link drawing identifier 2515 identifying the drawing of the link destination are stored is further provided in the management information of each of the management objects so that with respect to the management object having the link information set on the network drawing, the link information of interest is also registered in the management database.

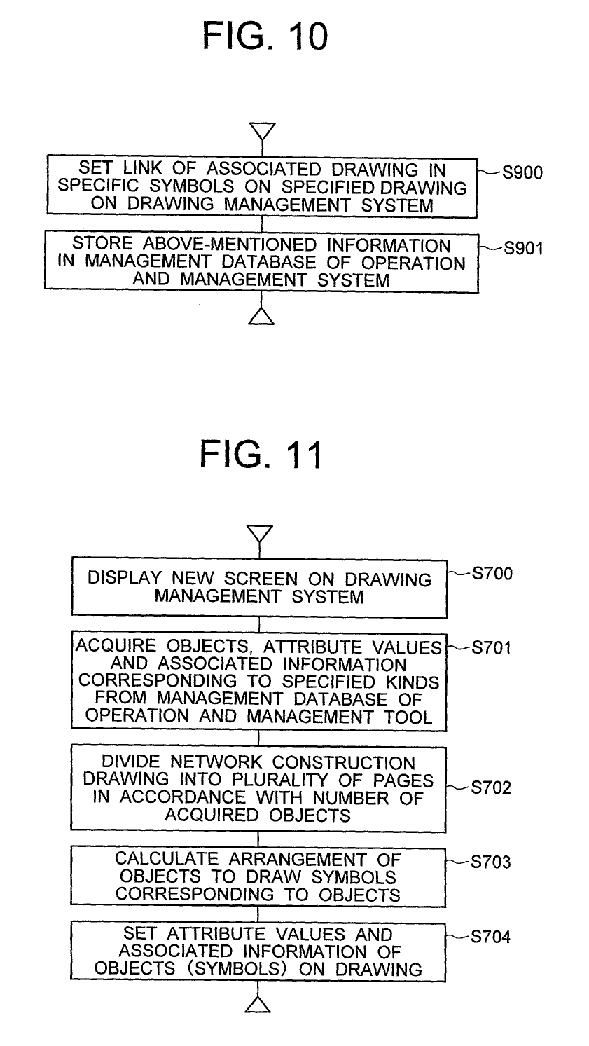

FIG. 10 is a flow chart explaining a processing for supporting the network management, executed in the network system according to an embodiment of the present invention.

The network designer assigns a drawing identifier to the network drawing on the network design terminal 30 and if necessary, sets link destination drawing identifiers in the symbols arranged in the network drawing (Step S900). Also, the data converting unit 515 of the management host 50 generates management informations from the drawing identifiers of the network drawing and the symbol data, respectively, to register the management information thus generated in the management information storing unit 500 (Step S901). By the way, of these processings, the processing in Step S900 will be executed in Step S600 of FIG. 7, and the processing in Step S901 will be executed in Step S604 of FIG. 7.

Now, after the management information concerned with each of the management objects on the network system has been registered in the management information storing unit 500, a network manager, as will hereinbelow be described, can carry out the network operation and management works on the terminal 40 for network management. By the way, in this case, the work entailing the monitoring of the work state of the network system is supposed as the network operation and management works by a network manager.

FIG. 11 is a flow chart explaining a processing for making the display device of the terminal 40 for network management display the network construction drawing showing the state of the network system.

When intending to carry out the network operation and management works, first of all, the network manager activates the management application program on the network management terminal 40, thereby making the display device display the console screen for management (Step S700). If a network manager inputs an instruction to transmit the network construction drawing data after having specified one or more kind names of the management objects (e.g., a host, a router, all of kinds or the like) on the console screen, then a transmission request containing the specified kind names is transmitted from the network management terminal 40 to the management host 50.

In the management host 50 which received that request, the following processings (Steps S701 to S704) are executed. First of all, in accordance with an instruction issued from the network construction drawing transferring unit 521, the management information reading unit 512 fetches a plurality of sets of management information of the management objects corresponding to the specified kind names from the management information storing unit 500 (Step S701). Thereafter, the data converting unit 515, on the basis of the total number of management informations, determines the number of pages of the network construction drawing (Step S702), Then, the data converting unit 515, on the basis of the management object information contained in management informations, determines the layout, on each of the pages, of the symbols of the management objects represented by management object informations. Then, the network construction drawing data is generated in which the symbols are arranged in accordance with that layout (Step S703).

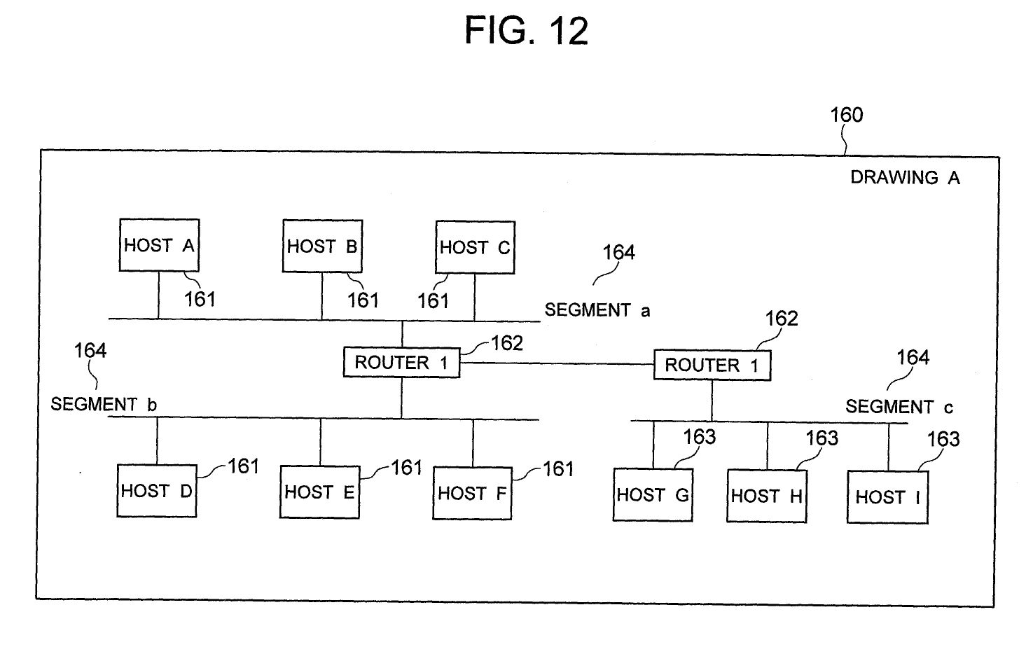

FIG. 12 is a schematic diagram showing one example of a network construction drawing displayed on the management console screen according to an embodiment of the present invention.

As shown in FIG. 12, a symbol 164 representing a segment corresponding to a sub-network, and symbols 161, 162 and 163 of the management objects are arranged in a network construction drawing 160 produced in this example. By the way, in the case where as shown in FIG. 9, the link drawing identifier 515 and the drawing identifier 516 are both contained in the management information, at this time, the network construction data is generated for each drawing identifier. In addition, while in this example, the symbols of the group of management objects are arranged on the network construction drawing without distinction, it may also be available that the group of management objects are classified into a plurality of groups in accordance with the predetermined rules (e.g., for each kind of router, host or the like) and the symbols of the group of the management objects are arranged in the network construction drawing every group.

After the network construction drawing data has been generated in such a manner, further, the data converting unit 515 sets the information contained in the management object informations as the symbol data (Step S704). By the way, in the case where as shown in FIG. 9, the link drawing identifier 515 and the drawing identifier 516 are both contained in the management informations, at this time, the data converting unit 515 sets the link drawing identifier as the destination of the link in the symbol data. Thereafter, the network construction drawing transferring unit 521 returns the network construction drawing data to the network management terminal 40.

Then, in the terminal 40 for network management which has received the network construction drawing data, the network construction drawing receiving unit 400 makes the display device display the network construction drawing represented by that network construction drawing data. A network manager can customize suitably the display setting (e.g., the size of the symbol) of the network construction drawing, and the like depending on his/her taste, the utilization environment or the like, and in addition thereto, can carry out the custmization suitable for the various kinds of network operation and management works such as the change of the connection relationship between the management objects and the change of the attribute information of the management objects by manipulating the symbols on the network construction drawing. As described above, since the network construction drawing for the management console screen is automatically produced from the management information stored in the management database, it is possible to save the labor required for the production, of the network construction drawing for the management console screen, which is conventionally carried out either after completion of the network construction or after completion of the change of the network construction. That is, there is no need for maintaining individually the network drawing used in the network design and the network construction drawing used in the network operation and management. For this reason, the burden for the works of the network operation and management is lightened.

In addition, a network manager, as will hereinbelow be described, can also monitor the work states of the management objects.

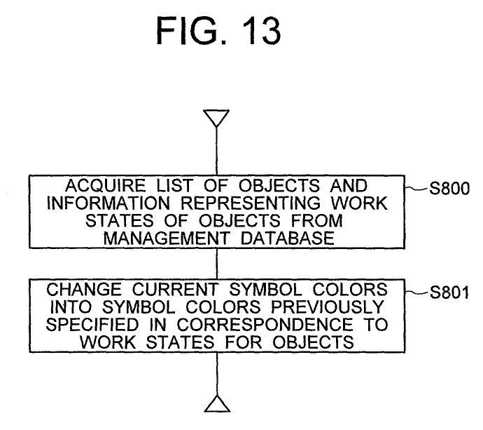

FIG. 13 is a flow chart explaining a processing for reflecting the state information stored in the management database on the display of the symbols on the network construction drawing. In this case, there is taken as an example the case where colors of the symbols of the management objects are changed in accordance with the state information of the management objects.

As described hereinabove, the network monitoring/controlling unit 514 of the management host 50 collects periodically state informations from the management objects and updates successively the state information, contained in the management information of the management information storing unit 500, of state informations. Therefore, the contents of the state information contained in the management information represent in real time the work states of the management objects.

When intending to monitor a work state on the network system, the network manager, for example, inputs an instruction to transmit the state information through the console screen. As a result, a request for transmitting the state information is transmitted from the network management terminal 40 to the management host 50. In the management host 50 which has received that request, the management information reading unit 512 fetches the object names and the state information of the management objects from the management information storing unit 500, respectively (Step S800). Thereafter, the data converting unit 515, on the basis of the correspondence information in which the kinds of colors of the state information are made correspond to colors of the state information, determines the colors corresponding to state informations of the management objects. The network construction drawing transferring unit 521 transmits the object names of the management objects to the network management terminal 50 with the object names being made correspond to identification informations of the colors determined for the management objects of interest. In the terminal 50 for network management which has received the information (the object name and the color identification information), the network construction drawing receiving unit 400, on the basis of the information thus received, changes the display colors of the symbols contained in the network construction drawing being displayed on the display device. To put it concretely, the display colors of the symbols are changed into the colors represented by the identification information made correspond to the same object names as those set in the symbols of interest (Step S801).

By executing the above-mentioned processings, the network manager can grasp visually the work states of the management objects on the network construction drawing displayed on the display device of the terminal for network management. By the way, while in this case, the symbols corresponding to the management objects are displayed with the colors dependent on the state information of the management objects of interest, the state information of the management objects may be grasped from the network construction drawing by employing any of other display methods. For example, icons representing the state information of the management objects may also be displayed with the icons being appended to the symbols of the management objects of interest.

While in the above-mentioned construction, the terminal for network design and the terminal for network management are provided separately from each other, in the case where a network designer and a network manager are the same person, and so forth, either one management object or one management host may perform both of the function as the terminal for network design and the function as the terminal for network management. In such a case, the network drawing produced in construction of the network system may also be employed as the network construction drawing on the management console screen in its entirety. To put it concretely, the network drawing produced in construction of the network system is displayed on the management console screen, and the state information of the management objects is reflected only on the symbols, which are made correspond to the management objects, of the symbols on the network drawing. For this reason, the network manager can grasp visually the work states of the management objects on the network drawing produced in construction of the network system.

In addition, while in the above-mentioned construction, the management application program for displaying the console screen is installed in each of the terminal for network design and the terminal for network management, this construction is not necessarily adopted. For example, the construction may also be adopted in which a Web browser is installed in each of the terminal for network design and the terminal for network management, a Web server program is installed in the management host, and in response to a request made from either the terminal for network management or the terminal for network design, an HTML document for displaying the console screen is transmitted from the management host.

In addition, while in the above-mentioned construction, the network apparatuses constituting the network system are treated as the management objects, this construction is not necessarily adopted. For example, in the job system for executing the jobs corresponding to the processings of a series of processings forming one work, a series of jobs may also be managed as the management objects. For example, the jobs corresponding to a series of processings (the processing for taking in an accepted data from a branch, the processing for calculating the number of acceptance of products, the processing for producing a document for sending an order, the processing for calculating a sum of moneies requested by customers, the processing for producing bills, and the like) forming the work for accepting and sending an order can be managed as the management objects. The description will hereinbelow be given with respect to the case where a series of jobs forming one work are managed as the management objects by taking as an example the job system for executing five jobs 1, 2, 3, 4 and 5 forming one work. But, in this case, the description will now be given with as the principal object a point of difference from the processing in the above-mentioned case where the network apparatuses constituting the network system are managed as the management objects.

In the case as well where the job system for executing five jobs 1, 2, 3, 4 and 5 is constructed or changed, roughly similarly to the above-mentioned case where the network system is constructed, the processings are executed in accordance with the flow chart shown in FIG. 7. But, the present case is different in the following point from the above-mentioned case.

In the case where the network system is constructed, first of all, in Step S600, the network drawing data is generated using the graphic application program of the network design terminal 30. However, in the case where the job system for executing the five jobs 1, 2, 3, 4 and 5 is constructed or changed, in Step S600, a job-net drawing (drawing for design) representing a flow of a series of jobs 1, 2, 3, 4 and 5 (hereinafter, referred to as “a job-net” for short, when applicable) is produced.

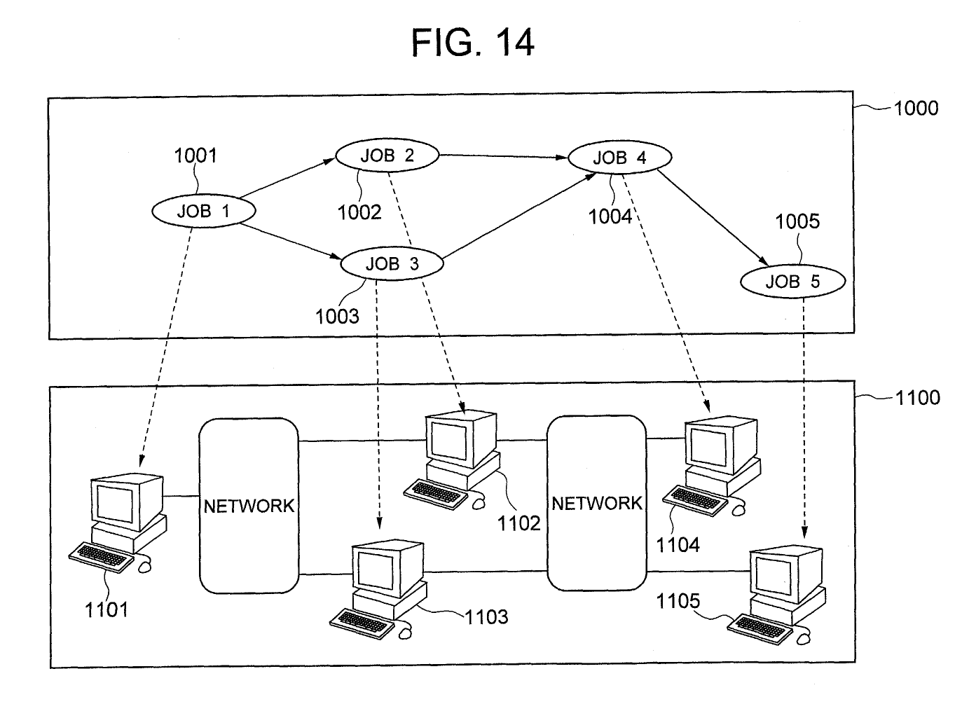

FIG. 14 is a schematic diagram showing one example of a job-net drawing and a network drawing according to an embodiment of the present invention.

Symbols 1001, 1002, 1003, 1004 and 1005 representing the jobs are arranged in a job-net drawing 1000, and attribute informations of the corresponding jobs (a job name, a scheduled time of starting a job, a scheduled time of ending a job, and if necessary, a drawing identifier of a link destination drawing, and the like) is set in these symbols. By the way, the execution order of the jobs which is determined by a scheduled time of starting execution and a scheduled time of ending execution is indicated by the solid line arrows in the job-net drawing 1000 shown in FIG. 14.

Thereafter, the job system designer makes the correspondence between symbols 1101, 1102, 1103, 1104 and 1105, on the network drawing, which were produced in construction of the network system and the symbols 1101, 1102, 1003, 1004 and 1005 on the job-net drawing 1000, whereby a series of jobs 1, 2, 3, 4 and 5, as shown by broken line arrows, are assigned to the information processors on the network system, respectively. As a result, in the symbols 1001, 1002, 1003, 1004 and 1005 on the job-not drawing 1000, machine names of the information processors for executing the corresponding jobs are set.

After the generation of the job-net drawing data has been completed in such a manner, a job system designer, similarly to the case of the instruction to register the network drawing data, in Step S601, activates the management application program in the design terminal 30 to display the console screen for design on the display device and instructs the design terminal 30 to register the job-net drawing data on the console screen for design. But, in this case, a job system manager needs to input the information required for construction of the job system, e.g., a job-net name, a date of activating the job-net (a day of the week or the activation date), a time of activating the job-net, and the like in addition to the drawing identifiers (a file name and the like) assigned to the newest job-net drawing data containing therein the symbol data. As a result, after a registration request containing therein the job-net drawing data has been transmitted from the terminal 30 for network design to the management host 50, the data converting unit of the management host 50 generates the management information (the job-net management information and the job management information) concerned with the job-net from the information contained in the registration request of interest. To put it concretely, the data converting unit 515 fetches the symbol data of the jobs each becoming the management object from the job-net drawing data to convert the data format of those symbols into the data format of the job management information registerable in the management information storing unit 500.

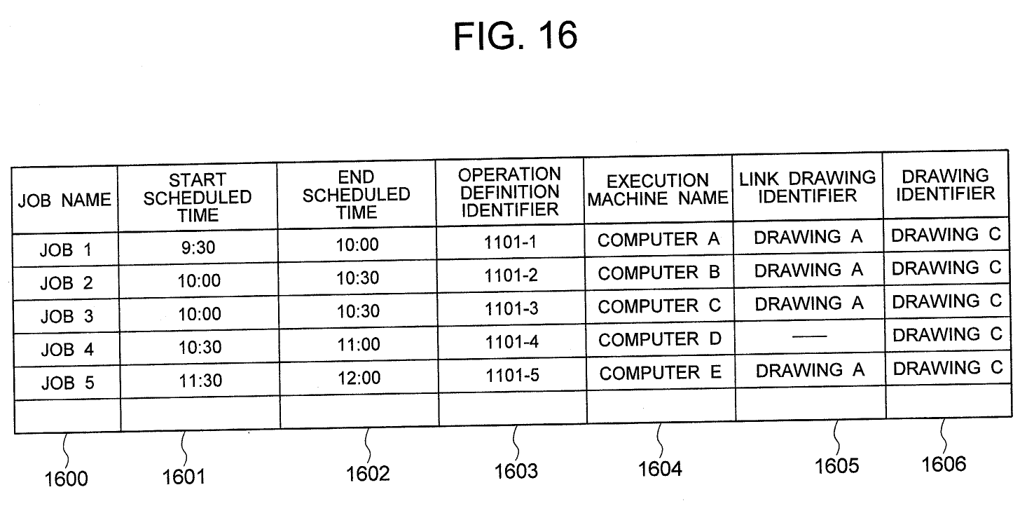

FIG. 16 is a diagram showing schematically the data structure of the job management information contained in the management information according to an embodiment of the present invention.

As shown in FIG. 16, a job name 1600, a scheduled time 1601 of starting a job, a scheduled time 1602 of ending a job, a machine name 1064 of the information processor for executing a job, a drawing identifier 1605 of a link destination drawing, a drawing identifier 1606 of a job-net drawing, an operation definition identifier 1603 assigned uniquely by the system are stored every job in the job management information generated at this time every job.

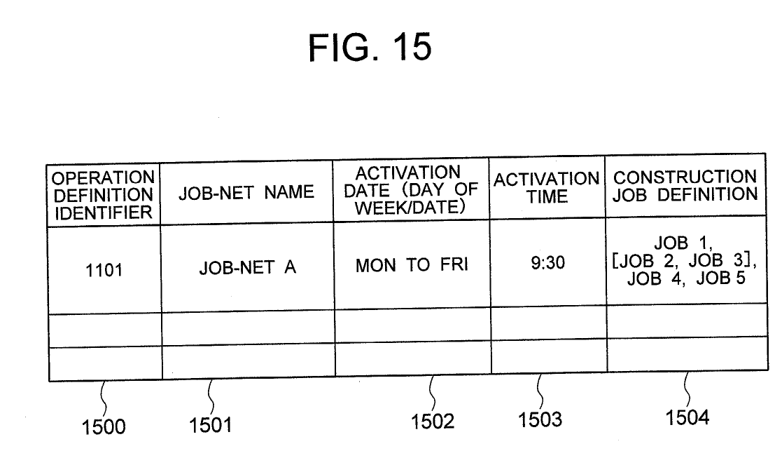

FIG. 15 is a diagram showing schematically the data structure of the job-net management information contained in the management information according to an embodiment of the present invention.

The job-net management information, as shown in FIG. 15, contains therein an operation definition identifier 1500 assigned uniquely by the system, a job-net name 1501, a date 1502 of activating a job-net, a time 1503 of activating a job-net, and construction job definition information 1504 containing therein the job names constituting the job-net. By the way, in this case, the operation definition identifier 1603 of the job management information of the jobs constituting the job-net has the structure in which a branch number is added to the operation definition identifier 1500 of the job-net management information of the job-net.

Thereafter, roughly similarly to the above-mentioned case where the network system is constructed, the management information generated in Step S601, in accordance with the check result in Step S603, is newly registered or updated and registered in the management information storing unit 500 (Steps S604 and S605). In addition, if the symbol is deleted from the job-net drawing (Step S605), then job management information and the like stored in the management information storing unit 500 after having made the confirmation (Step S600) for a job system designer.

After the management information concerned with the job-net has been registered in the management information storing unit 500, the management host 50 instructs the information processor(s) to execute the job(s) in accordance with the conditions established in the management information of interest. As a result, the job-net is executed on the job system.

According to the above-mentioned processings, the management information required for the job-net execution is autimatically generated from the job-net drawing data generated or changed in construction or change of the job system to be registered in the management database. For this reason, a job system manager can save the labor required for the initialization and the setting change, of a plurality of sets of management information, which are conventionally carried out for the operation and management of the job system.

In addition, as described above, the construction of the job-net can also be displayed graphically on the display device of the network management terminal 40 on the basis of the management information which is automatically registered in the management database. In this case as well, roughly similarly to the above-mentioned case where the network construction drawing showing the state of the network system is displayed on the display device of the network management terminal 40, the process proceeds in accordance with the flow chart shown in FIG. 11. But, the present case is different in the following point from the above-mentioned case.

When intending to carry out the operation and management work of the job system, a job system manager, similarly to the above-mentioned case needs to make the display device display the console screen for management (Step S700) to specify a job name and the like on that console screen for management and also to input an instruction to transmit the job-net drawing data. As a result, if a transmission request containing therein a specified job-net name and the like was transmitted, then in the management host 50 which has received this request, the following processings are executed, and the job-net drawing produced in the construction of the job system is reproduced as the drawing for management. First of all, the management information containing therein the specified job name is fetched from the management information storing unit 500 (Step S701), and the number of pages is determined on the basis of the total number of jobs defined in job management information contained in that management information (Step S702). Next, the layout, on the page, of the symbols of the job is determined on the basis of that job management information and the data of the job-net drawing in which the symbols are arranged in accordance with that layout generated (Step S703). After the job-net drawing data has been generated in such a manner, information contained in the management information is set as the symbol data (Step S704). Thereafter, the job-net drawing data is sent as a reply to the network management terminal 40 and the job-net construction represented by the job-net drawing data is displayed on the display device.

As described above, in the case as well where the jobs constituting the job-net are managed as the management objects, the job-net drawing for management console screen is automatically produced from the management information stored in the management database. Therefore, it is possible to save the labor required for the production of the job-net drawing for the management console screen which is conventionally carried out for the operation and management of the job system. In addition, if the management host receives the report of end of the job from the information processor which has carried out that job to add the information of the job end state (normal end, or error) represented by that report to the management information within the management database, then similarly to the above-mentioned case, it is also possible to display the symbols on the job-net drawing of the management console screen using the colors dependent on the end state of the job.

As set forth hereinabove, according to the present invention, it is possible to lighten the work burden of operation and management imposed on a network system manager.

It should be further understood by those skilled in the art that the foregoing description has been made on embodiments of the invention and that various changes and modifications may be made in the invention without departing from the spirit of the invention and the scope of the appended claims.

What is claimed is:

1. A management supporting method of supporting operation and management works by a management host for managing a plurality of management objects, said method comprising the steps of:
storing, for the every management object, management information which contains attribute information of the management objects and on which states of the management objects are reflected, in a database;
receiving design drawing data containing therein symbols which are made correspond to the management objects, respectively, and in which the attribute information of the management objects is set;
generating, on the basis of the attribute information of the symbols, the management information on which the states of the management objects corresponding to the symbols contained in the design drawing data are reflected; and
registering the management information in the database.

2. A network management supporting method according to claim 1, further comprising the steps of:
when having received a request for a drawing for management, fetching the management information of the management objects to be shown in the drawing for management from the database;
generating the symbols in which the attribute information contained in the management information is set from the management information fetched from the database; and
producing the drawing for management, in which the symbols are arranged, as data for display in a source of the transmission request.

3. A network management supporting method according to claim 2, further comprising the step of: displaying the symbols arranged in the drawing for management, every management information of the management objects corresponding to the symbols, in accordance with the states of the management objects in the step of generating the drawing for management.

4. A network management supporting method according to claim 2, further comprising the step of: deleting from the database the management information of the management objects, for which no management information is newly generated from the data for design, of the management objects having the management information registered in the database.

5. A network management supporting method according to claim 2, further comprising the steps of:
classifying the symbols generated from the management information fetched from the database into a plurality of groups in accordance with the predetermined rules; and
producing, every group, the drawing for management in which the symbols belonging to the group of interest are arranged.

6. An information processor for managing a plurality of management objects, comprising:
a database in which every management object, management information containing therein attribute information of the management object of interest and having a state of the management object of interest reflected thereon is stored;
drawing receiving means for receiving design drawing data containing therein symbols which are made respectively correspond to the management objects and in which attribute information of the management objects is set;
data converting means for generating the management information, on which the states of the management objects corresponding to the symbols contained in the design drawing data received by the drawing receiving means are reflected, on the basis of the attribute information of the symbols; and
management information registering means for registering the management information generated by the data converting means in the database.

7. An information processor according to claim 6, further comprising:
drawing transferring means for outputting drawing data for management representing the drawing for management; and
management information reading means for reading out the management information of the management objects to be shown in the drawing for management from said database,
wherein said data converting means generates the symbols, in which attribute information contained in the management information is set, from the management information fetched from the database by the management information reading means, and generates drawing data, in which the symbols are arranged, as drawing data for management outputted by the drawing transferring means.

8. An information processor according to claim 7, wherein said data drawing means displays the symbols arranged in the drawing for management every management information of the management objects corresponding to the symbols of interest in accordance with the states of the management objects of interest.

9. An information processor according to claim 6, wherein the management information registering means deletes from the database the management information of the management object(s), for which the data converting means did not newly generate the management information, of the management objects having the management information registered in the database.

10. An information processor according to claim 6, wherein the data converting means classifies the symbols generated from the management information fetched from the database into a plurality of groups in accordance with the predetermined rules and produces, every group, the drawing for management in which the symbols belonging to the group of interest are arranged.

11. A network system, comprising:
an information processor; and
a plurality of management objects each becoming a management object managed by the information processor,
wherein the information processor comprises:
a database in which every management object, management information containing therein attribute information of the management object of interest and having a state of the management object of interest reflected thereon is stored;
drawing receiving means for receiving design drawing data containing therein symbols which are made respectively correspond to the management objects and in which attribute information of the management objects is set;
data converting means for generating the management information, on which the states of the management objects corresponding to the symbols contained in the design drawing data received by the drawing receiving means are reflected, on the basis of the attribute information of the symbols; and
management information registering means for registering the management information generated by the data converting means in the database.

12. A program executed by a management system having a database in which management information containing therein attribute information of management objects and having states of the management objects reflected thereon is stored every management object, the program comprising the steps of:
receiving design drawing data containing therein symbols which are made respectively correspond to the management objects and in which attribute information of the management objects is set;
generating the management information, on which the states of the management objects corresponding to the symbols contained in the design drawing data are reflected, on the basis of the attribute information of the symbols; and
registering the management information in the database.

13. A program according to claim 12, further comprising the steps of:
fetching the management information of the management object(s) to be shown in a drawing for management from the database;
generating the symbols, in which the attribute information contained in the management information is set, from the management information fetched from the database; and
processing the drawing for management having the symbols arranged therein as the data for display in a source of a transmission request.

14. A program according to claim 13, further comprising the step of: displaying the symbols arranged in the drawing for management, every management information of the management objects corresponding to the symbols, in accordance with the states of the management objects.

15. A program according to claim 12, further comprising the step of: deleting from the database the management information of the management objects, for which no management information is newly generated from the data for design, of the management objects having the management information registered in the database.

16. A program according to claim 12, further comprising the step of:
classifying the symbols generated from the management information fetched from said database into a plurality of groups in accordance with the predetermined rules; and
producing, every group, the drawing for management in which the symbols belonging to the group of interest are arranged.

17. A storage medium readable by a computer, and having the processings stored therein and executed by a management system having a database in which management information containing therein attribute information of management objects and having states of the management objects reflected thereon is stored every management object, the storage medium comprising the steps of:
receiving design drawing data containing therein symbols which are made respectively correspond to the management objects and in which attribute information of the management objects is set;
generating the management information, on which the states of the management objects corresponding to the symbols contained in the design drawing data are reflected, on the basis of the attribute information of the symbols; and
registering the management information in the database.
